(19) United States
(12) Patent Application Publication
(10) Pub. No.: US 2010/0288422 A1
(43) Pub. Date: Nov. 18, 2010

(54) LOW-TEMPERATURE METHOD FOR JOINING GLASS AND THE LIKE FOR OPTICS AND PRECISION MECHANICS

(76) Inventors: Manfred Krauss, Jena (DE); Gudrun Leopoldsberger, Wuerzburg (DE); Gerhard Kalkowski, Jena (DE); Ramona Eberhardt, Bucha (DE); Andreas Tuennermann, Weimar (DE); Charlotte Jahnke, Buergel (DE); Simone Fabian, Jena (DE)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 12/808,591

(22) PCT Filed: Dec. 12, 2008
(86) PCT No.: PCT/EP2008/067442

§ 371 Date: Jun. 16, 2010

(30) Foreign Application Priority Data
Dec. 17, 2007 (DE) 10 2007 060 784.0

(51) Int. Cl. B29C 65/02; C03C 27/06

(52) U.S. Cl. 156/105; 156/99; 204/192.26

(57) ABSTRACT

The present invention relates to a method for joining two or more components made of glass, ceramic, and/or glass ceramic, using a soluble glass joining solution having sodium, potassium, and/or lithium ions and/or a silica sol, the joining solution being applied to joint surfaces between the components to be joined and solidified at mild temperatures, the method being either characterized in that the joining solution comprises an additive selected among boric acid, boron compounds from which boric acid can result by hydrolysis, aluminum acetates, aluminum silicate/NH₃/H₂O titanium compounds forming titanium hydroxy cations, water-soluble zinc compounds, water-soluble zircon compounds, and water-soluble yttrium compounds, wherein said additive is added in an amount that reduces the pH value of the underlying soluble glass, and/or characterized in that, after the joining solution is applied and the components to be joined are brought together and fixed, the joined components are dried by removing water at room temperature, wherein, after drying, the joined components are tempered in vacuum at a temperature in the range of up to 200° C. above room temperature.

Joining at least two components made of glass, ceramic and/or glass ceramic in the manufacture of optics by means of inorganic binding at low temperatures is well known. According to the present invention, it is carried out in a highly precise manner with stability and mechanical strength over the long term by means of inorganic solutions based on sodium, potassium and lithium soluble glass solutions or silica sols, with which a longer adjusting time is possible. The respective basic solution additionally contains for this, alone or combined, special inorganic and/or organic compounds of the following elements: Ti, B, Al, Y, Zr or Zn. The corresponding solutions are caused to react between the surfaces to be joined of components made of identical and/or different materials. By means of the additives, on the one hand, the reaction time, which is needed for adjusting the components, can be optimized; on the other hand, it was determined that compounds with high strengths are obtained with the joining solutions according to the present invention, the materials are not altered, and few limits are imposed on potential applications at elevated temperatures, moisture fluctuations and in terms of process engineering under vacuum.

The production of precision optical and mechanical systems in optics and microelectronics requires the precise bringing together of two or more glass and/or glass ceramic parts to guarantee a stable position of the components over the long term. Conventional joining processes at high temperature may lead to changes in the parts to be joined, stresses because of different thermal expansion or destruction. For new optical systems, e.g., ultralightweight mirrors in telescopes, beam splitters in projectors, microoptical systems or glass ceramic components for lithography tools, build-up and binding techniques for optical components made of very different materials are needed. A broad range of high- or low-refractive optical glasses and glass ceramics, to some extent with very low coefficients of thermal expansion, are available or are being developed for new applications. The current binding technique imposes limits on potential applications in terms of process engineering in many cases, however.

Low-temperature joining, also called “low-temperature bonding” (LTB), is a technique for joining two bodies, wherein a suitable joining solution is applied between the surfaces of parts to be joined. Here, a solid bond forms between the components due to a chemical reaction between the interfaces and the constituents of the joining solution at low temperatures. In terms of the present invention, compounds are defined as those that are produced typically in the range between room temperature and up to approx. 100° C. Processes for binding workpieces at low temperatures by means of using solder glasses are known from the state of the art. However, the temperatures necessary for this are above 150° C. The use of inorganic and inorganic-organic networks, to some extent produced via the sol-gel process, for bonds of components is, for example, mentioned in document EP 0414001 A2.

Joinings of inorganic, silicon-containing components (e.g., Si wafers) by means of silicate solutions, usually sodium silicate, are also state of the art. The binding between the components is produced by silicon-oxygen compounds forming during the reaction between the surfaces to be joined. The bonding of two materials by hydroxide-catalyzed hydration/dehydration at room temperature after formation of hydroxide ions on the two surfaces to be joined is described in U.S. Pat. Nos. 6,284,085 B1 and 6,548,176 B1. Powder of a silicate or silicate-containing materials is optionally used as filler here.

Joining experiments carried out by the inventors using pure potassium hydroxide solution KOH or sodium hydroxide solution NaOH as a joining solution were not successful (clouding of the joined surface, corrosion phenomena). This applies to the etching of the joined surfaces with hydrofluoric acid HF (e.g., 20%) and subsequent joining without and with joining solutions as well.

Besides the joining of phosphate glasses, the production of glass ceramic composites (see, e.g., U.S. Pat. No. 6,699,341 B2) for optical and optoelectronic components is also described in the state of the art. In this case, phosphoric acid-containing or silicic-acid-containing solutions are applied between the parts to be bonded. After dehydration at low temperatures (20° C. to 100° C.) and for a relatively long time (6 hours up to one week), very solid bond structures form. Without an exemplary embodiment being given for this, it is mentioned in this document that the addition of Al₂O₃ in an amount of up to 10 wt. % to the joining solution consisting of lithium, potassium, magnesium, calcium or barium silicate or mixtures thereof might improve the chemical durability of a bond of Zerodur substrates, wherein the chemical similarity between the substrate and joining solution is taken into account (Zerodur is a lithium aluminum silicate glass ceramic).

A special solution for low-temperature joining of aluminum-oxide-containing bodies, e.g., sapphire single crystals, using an aluminate-containing solution is described in German Application 10 2005 000 865 A1. In this case, the aluminate-containing solution is stabilized by a base. At least one of the surfaces provided for joining must be treated with chemically aggressive peroxomonosulfuric acid. At least one of the bodies to be joined must be an aluminum-oxide-containing body.

A joining technology for optical components made of glass and glass ceramic that offers advantages for at least one of the parameters of accuracy, stability, and lightweightness for many applications and overcomes current process-engineering limits in optics production is desirable.

Two or more components having identical and different material classes, chemical composition, structure and/or properties (glass, glass ceramic, possibly even ceramic) shall be manufactured at low temperatures (≦150° C.) in a mechanically precise manner according to the present invention by inorganic low-temperature joining for optics and precision mechanics, such that mechanically very solid compounds are formed and/or only slight optical losses occur in the transition zone. One of these materials shall preferably be a material with extremely low thermal expansion (so-called zero expansion material).

The surfaces to be joined are usually cleaned before joining, which should take place in the simplest manner and without special chemicals. In this case or additionally, they should be treated such that a favorable contact angle is formed with the joining solutions. This contact angle should be small (e.g., below 45°) in many cases, so that there is a good wetting of the joining surfaces. The contact angle may not be too small, however, so that the joining process can be technically performed, the joining and joining times can be made variable and no air is included between the joined surfaces. In special cases, on the other hand, the contact angle shall be relatively large (50° up to approx. 75°, or even 90° in extreme cases).

The object of the present invention is thus to control the rate of the chemical reaction of the joining process and to make it variable as required corresponding to the complexity of the joints. Thus, the curing process of the low-temperature joining can be slowed down and, consequently, an extended period can be made possible for fine adjustment of the components to be joined. As an alternative, the process shall also be able to be accelerated.

Besides the variation of the joining process (joined surfaces, temperature, time, support weights, atmosphere, vacuum), which may possibly provide a share therein, the variation of the properties of the joining solution and thus of the resulting joint is of decisive importance.

It was, in fact, surprisingly found that the joining time, i.e., the period during which a shifting or a (re-)adjusting of the components to one another is possible, can be changed by changing the pH value, which can be achieved by simply using the addition of Ti—, B—, Al—, Y—, Zr— or Zn-containing inorganic or organometallic solutions to joining solutions of common—usually commercially available—soluble glasses or silica sols.

For example, sodium silicate solutions (sodium soluble glass, e.g., Na₂Si₃O₇ from Riedel-de Haën), lithium silicate solutions (lithium soluble glass, e.g., Betol Li22 from Woellner), potassium silicate solutions (potassium soluble glass, e.g., K 42 from Woellner) or silica sols (e.g., LEVASIL® 300/30%, 200A/40% from Bayer) can be used as a basic joining solution. These solutions are solidified with the said additives at joining temperatures of preferably<150° C. into mechanically stable and temperature-stable joinings of two or more components. The networks forming between the joined surfaces each consist of silica, oxygen and the cation or cations that were added to the soluble glass solution or silica sol before the joining.

The reaction time of the solution, which is needed for adjusting the components, can be optimized using the additives; on the other hand, it was determined that frequently only slight optical losses occur with the joining solutions according to the present invention and compounds with increased strengths are produced. The latter can be observed especially in such joining solutions that, besides silica, contain the same types of cations that are also found in the parts to be joined.

By means of the present invention, the rate of the chemical reaction of the joining process can be controlled by varying the composition of the joining solution using suitable additives containing the ions to be used according to the present invention, so that, e.g., the necessary longer adjusting times (usually clearly more than 1 min.) are achieved in the joining of complex components with optical and mechanical functions.

An extension of the joining duration may in some cases be achieved even by a simple dilution of the joining solutions with water; however, the drying time is extended by this measure. Moreover, it is then frequently difficult to obtain a defect-free gap during drying, and especially in case of larger joined surfaces with larger distances to the edge of the joint, because the water can only be removed from the gap with difficulty. The formation of bubbles and other irregularities occur.

The material surfaces to be joined are preferably provided with a high-quality “optical polishing” by means of grinding and polishing before joining.

The geometric requirements on the surfaces are usually in such a way that a high surface quality, an as low as possible gap and an as homogeneous as possible layer thickness can be achieved. Gaps of ≦2 μm, preferably≦160 nm are desired. The flatness deviations (PV=peak-to-valley) should be less than 160 nm, i.e., better than λ/4 (for wavelength λ=633 nm), and the roughnesses should be ≦30 nm (RMS=root mean square), preferably≦3 nm. This applies especially to optical precision instruments. To join two thick and stiff, flat substrates, the flatnesses should be correspondingly adjusted in the starting state accordingly by preprocessing. For thin and flexible substrates, even greater flatness deviations are allowable, if the desired gap can be achieved by the corresponding pressing of the parts to one another. However, even non-flat substrates can be joined, e.g., two spherical shells or nonspherical surfaces, which fit into one another well.

In practice, typically flatnesses of λ/4 to λ/10 (approx. 160 nm to 60 nm) and roughnesses of 5 nm to 1 nm are achieved in round disks with a diameter of 25 mm, e.g., made of BK7 or ULE. The high requirements on the geometry of the joined surfaces must be met to achieve a sufficient proximity of the contact surfaces. Commercially available microscope slides used for comparison purposes made of conventional soda lime silicate glass have only flatnesses of 1 μm to 2 μm in spite of being produced via the float process.

Typical materials that can be joined at low temperatures are summarized in Table 1. These materials are glasses (flat glasses silica glasses, optical glasses) and a glass ceramic (Zerodur). Of course, the materials indicated in the table are only examples, to which the present invention is not limited.

TABLE 1
Joining materials

| | Type of glass/ |
|---|---|
| Name | components/composition (data in wt. %) |
| Microscope slide | Soda lime silicate glass: SiO₂; Na₂O; CaO |
| Lithosil ® (Schott) | Pure silica glass, SiO₂ glass, fused silica |
| ULE ® (Corning) | Titanium silicate glass: 93 SiO₂; 7 TiO₂ |
| BK7 (Schott) | Boron crown glass: 69.9 SiO₂; 10.2 B₂O₃; |
| | 8.6 Na₂O; 8.5 K₂O; 2.8 BaO) |
| Borofloat ® (Schott) | Borosilicate glass: 81 SiO₂; 13 B₂O₃; 2 Al₂O₃; |
| | 4 Na₂O/K₂O |
| Zerodur ® (Schott) | Glass ceramic with 70-80% crystalline phase as |
| | high quartz structure: SiO₂; Li₂O; Al₂O₃ |

Typical properties of the materials to be joined are summarized in Table 2.

TABLE 2
Properties of joining materials

| | | | Strain point, | Density |
|---|---|---|---|---|
| | Coefficient of thermal | Refractive | T₁₀, η = 10^{13.5} | (25°) |
| Name | expansion [10⁻⁶° C.] | index | Pa · s [° C. ] | [g/cm³] |
| Microscope slide | 8.7 (0-300° C.) | nD = 1.52 | 470 | 2.49 |
| Lithosil ® | 0.5 (35-100° C.) | nD = 1.45837 | 980 | 2.2 |
| ULE ® | 0.03 (0-300° C.) | nD = 1.4828 | 890 | 2.21 |
| BK7 | 8.3 (20-300° C.) | nD = 1.51673 | T_{g} = 557 | 2.51 |
| Borofloat ® | 3.25 (20-300° C.) | nD = 1.47133 | 518 | 2.2 |
| Zerodur ® | 0.1 (0-50° C.) | nD = 1.5424 | | 2.53 |

Before the low-temperature joining, the materials to be joined are suitably cleaned, if required. RCA hot cleaning (basic standard cleaning process for silica wafers, 1960, W. Kern, Radio Corporation of America) of the two surfaces to be joined (clean, hydrophilic, activation of the cleaning agent, ultrasound) is especially possible for this. Here, organic and metallic impurities are removed from the surfaces to be joined (complexing of, e.g., Cu, Ag, Au, Zn, Cd, Ni, Co, Cr by NH₃, formation of insoluble hydroxides and/or oxides or soluble chlorides, e.g., with the ions Al³⁺, Fe³⁺). The contact angle between joined surfaces and joining solution is below 45° due to this process, and preferably it is between 1° and 20°. As an alternative to RCA hot cleaning, so-called “bath cleaning” is carried out, in which cleaning is performed with special surfactants (e.g., Optimal 9.9 and GS10 from the firm of Olschner/Gottmardingen) and with ultrasound support. Especially Zerodur samples cannot be cleaned without corrosion of the joined surfaces by means of the RCA process. Therefore, the Zerodur samples are preferably cleaned with a modified RCA process (without the step of cleaning with hydrofluoric acid HF) or by means of bath cleaning.

As an option, the joined surfaces are additionally activated. This is carried out, for example, with a nitric acid treatment, e.g., treatment for 30 min. in 10% HNO₃, rinsing off with deionized water, and draining times of 1.5 hr. to 2 hr. In relation to increasing the adjusting and curing time of the joints, a silanization of the joined surfaces is also possible in order to achieve a hydrophobic contact angle (approx. 50° to 75°) between joined surface and joining solution. For example, fluorosilanes (e.g., perfluorododecyl-triethoxysilane), organically cross-linkable alkoxysilanes, such as MEMO (3-methacryloxy-propyltrimethoxysilane) or alkoxysilanes modified with amino groups, such as AMO (amino-propyltrimethoxysilane) can be used as silanes.

Depending on the respective joining task, the contact angle should thus be selected to be small (for a good, uniform distribution of the joining solution on the joined surface with fast curing) or large (the latter preferably by means of a silanization, which allows a “pushing on,” i.e., an opposite movement of the joining materials, for a longer time, while a slow curing causes long adjusting times).

FIG. 1 shows a comparison of the measures that are taken for RCA cleaning or bath cleaning.

Since all classes of materials to be joined according to the present invention contain SiO₂ as a main component, alkali silicate solutions (soluble glasses) having different compositions (Na, K, Li) and concentrations (1 to 30 wt. %) or silica sols of different solids contents (e.g., 300/30%, 200A/40%, wherein the first number indicates the specific surface of SiO₂ and the second number indicates the SiO₂ content, in relation to 100 parts of silica sol) with additions of inorganic and organometallic compounds of the cations according to the present invention are used as the basic joining solutions. Silica sols are aqueous, colloid-disperse solutions of amorphous silicon dioxide in water. Soluble alkali silicates hydrolyze in water, since silicic acid is a weak acid. They tend toward condensation in solution. The so-called soda or soda-soluble glasses contain SiO₂ and Na₂O as main components. They are the soluble glasses of greater technical relevance. The SiO₂:Na₂O ratio fluctuates from 3.9 to 4.1 in high-silicic-acid-containing soluble glasses, 3.3-3.5 in neutral soda soluble glass and 2.0-2.2 in alkaline soluble glass. In potassium soluble glasses, the SiO₂:K₂O ratios are between 1:1 and 3.9:1. In lithium silicate solutions, the SiO₂:Li₂O molar ratio is between 2.5 and 4.5.

Very stable, low-temperature joinings (strength, long-term stability) are found when using neutral to slightly basic sodium soluble glass with a SiO₂:Na₂O molar ratio of 3.5 (solids content approx. 39%), with potassium soluble glass with a SiO₂:K₂O molar ratio of 2.9 (solids content approx. 40%) and with lithium soluble glass with a SiO₂:Li₂O molar ratio of 2.5 (solids content approx. 27.2) as a basic material for the joining solution. The pH values of the alkaline alkali soluble glasses are between 11.8 and 12.8 (see Table 5 below).

Monomolecular silicic acid is only available in a high dilution. By reducing the OH concentration, higher condensed silicic acids are formed more or less quickly (depending on concentration and pH value), which are increasingly poorly soluble with increasing degree of condensation and ultimately lead to a solid joining at low temperatures. Silica sols have a pH value of approx. 10 (Table 4). Very good (solid) joinings were obtained with silica sols with a specific surface of the SiO₂ and with SiO₂ contents (in relation to 100 parts of silica sol) of 100/45%, 300/30% and 200A/40% (A designates the special low-alkali content of the silica sol).

The joining times and adjusting times should be longer than 1 min. and should preferably be at least 3 min., so that even complicated components may be joined with high precision.

Table 3 shows exemplary basic soluble glass and silica sol solutions. The basic joining solutions are altered by means of the additives according to the present invention such that an extension of the binding and curing times of the joinings occurs and so that the time available for fine adjustment is extended to the required extent (1 to 5 min. longer).

TABLE 3
Examples of soluble glass or silica sol solutions (sodium soluble
glass (Na₂Si₃O₇; M = 242.23 g/mol; SiO₂:Na₂O = 3.48;
solids content 39%)) and curing time (pot life)

| | | Curing time |
|---|---|---|
| Name | Composition | (pot life) |
| ISC 1 | Pure Na soluble glass | 1-2 min. |
| ISC 2 | Na soluble glass:water = 1:1 | 2 min. |
| ISC 3 | Na soluble glass:water = 1:2 | 4 min. |
| ISC 4 | Na soluble glass:water = 2:1 | 3 min. |
| ISC 5 | 20 g of Na soluble glass + 2 g | 5 min. |
| | of saturated H₃BO₃ solution | |
| | (5%) | |
| Potassium soluble glass | K₂Si₃O₇, solids content 40% | 3 min. |
| Lithium soluble glass | Li₂Si₃O₇, solids content 27.2% | 3 min. |
| Levasil 300/30% | Silica sol 300 m²/g SiO₂, 30% | 3 min. |
| | SiO₂/100 parts of silica sol | |

The inventors surprisingly found that the joining time of each system increases with decreasing pH value. The components according to the present invention to be added to the basic materials lower their pH value, respectively. Inversely, the binding and curing time can be shortened by an increase in pH value by means of correspondingly more highly basic additives, which may be advantageous in some situations in the case of simple geometries of the components to be joined. The materials do this differently and perform otherwise additional, different tasks, which is explained in detail below.

A. Silicon Compounds

The formation of highly condensed silicic acids (isopoly acids) is a slow-running process. By means of adding acidic solutions having cations of the elements Ti, B, Al, Y, Zr or Zn, such as boric acid, saturated B₂O₃ suspension, titanium sulfate hydrate, yttrium acetate, aluminum acetate, and titanium chloride according to the present invention to a soluble glass solution, the monomolecular dispersed silicic acid is released:

[H₂SiO₄]²⁻+2H⁺→H₄SiO₄

At first, it remains as such in solution. However, soluble glass also contains portions of aggregated silicic acid already before the addition of acidic components, so that low-temperature joinings may also occur without acidifying directly with soluble glass. Soluble glass acts as a binder. The binding mechanism is based on neutralization (by CO₂ in air), removal of water and cooling off. According to the present invention, the removal of water is induced by increasing the temperature (up to 200° C. max., preferably below 100° C.), vacuum or water-removing chemical substances (e.g., silica gel). In aqueous silica sols, amorphous silicon dioxide is stabilized with small additions of NaOH. If the OH concentration is reduced by adding acidic additives, more highly condensed silicic acids (isopoly acids) form more or less quickly, which are increasingly poorly soluble with increasing degree of condensation (see above).

As mentioned, individual or combined solutions of chemical compounds are added to the respective basic joining solution (concentrations of 1 wt. % to 50 wt. %, preferably 1 wt. % to 35 wt. %). These have both an effect on the properties of the joining solution and on the subsequently formed solid joinings and the joined components. The additives to the basic joining solutions are listed below and their effects on the joining solution are shown:

B. Boron Compounds

The following are suitable for joining boron-containing materials (BK7, Borofloat):

a) Boric acid H₃BO₃. It is readily soluble in water in heat, but poorly soluble in cold and it is a weak acid. It is used for the neutralization of basic soluble glass solution or lightly basic silica sols, slows down their chemical reactions with the joined surfaces and the CO₂ in air, as well as formation of water-insoluble boron-silicate bonds SiO—B from water-soluble alkali borates. Thus, the joining and adjusting times are extended. The joint is additionally stabilized and strengthened by dehydrating and conversion into metaboric acid [BO₂]ₙ at 70° C. Trimethyl borate B(OCH₃)₃ is saponified by water into boric acid and methyl alcohol, which leads to extension of the joining times, since boric acid is first formed during the joining process.

b) B₂O₃. This compound dissolves exothermally in water into orthoboric acid H₃BO₃ (up to 5 vol. %)

c) Trimethyl borate B(OCH₃)₃

C. Aluminum Compounds

Aluminum diacetate HOAl(OOCCH₃)₂ (aluminum acetate) and aluminum triacetate [sic, typo in the original—Tr.Ed.] Al(OOCCH₃)₃ have a basic reaction in aqueous solution and lead catalytically to the slowing down of the solidification of the alkaline solutions. In alkaline solutions, Al(OH)₃ may form, which aggregates into higher-molecular-weight particles, which finally lead to the colloidal distribution, “Al(OH)₃ gels” form, which lead, due to dehydration, to increased stability of the Si—O—Al joining and to the slowing down of the chemical curing reaction.

a) Basic aluminum triacetate Al(OOCCH₃)₃

b) Basic aluminum diacetate HOAl(OOCCH₃)₂

c) Aluminum silicate each in the presence of NH₃.H₂O are suitable for the present invention.

Upon heating, dehydration takes place with the formation of oxides. This leads to increased stability of the Si—O—Al bond. By adding ammonia solution (NH₃.H₂O) to one of the above-mentioned aluminum-containing solutions, the Al(OH)₃ formed in the interim can dissolve in water with the formation of complexes: Al(OH)₃+OH⁻→[Al(OH)₄]⁻, this solution acts just like aluminum acetate itself as a chemical buffer solution (salt of water acid and strong base). Buffer solutions reduce the OH⁻ ion concentration of the soluble glass or silica sol solutions and extend the curing times, e.g.:

[Al(OH)₄]⁻→Al(OH)₃+OH⁻

NH⁴⁺+OH⁻→NH₄OH→NH₃↑+H₂O

Aqueous, weakly basic ammonia solution NH₃.H₂O is generally given as an additive to the cation solutions used in order to prevent the formation of hydroxide precipitates due to the formation of soluble complex compounds (e.g., [Al(OH)₄]⁻, [Zn(NH₃)₄]²⁺] in the joining solutions (not in Ti—, Zr— Y-containing solutions).

D. Titanium Compounds

For joining titanium-containing materials (e.g., ULE): Ti⁴⁺ ions do not occur in aqueous solution, hydroxy cations such as [Ti(OH)₃(H₂O)₃]⁻or [Ti(OH)₂(H₂O)₄]²⁺, whose composition is highly dependent on the pH value, are always present; titanium oxide hydrate is an amphoteric compound, which has only a weakly basic reaction; upon removal of water, —O—Ti—O—Ti—O chains form, which, with dissolved Si species of the alkali silicates in the joining solutions, lead to longer curing times as well as —O—Si—O—Ti—O— strong bond or strong bonds. In the aged state, titanium oxide hydrate is poorly soluble in acids and alkalis after low-temperature joining. Suitable for the present invention are above all:

a) Titanium sulfate hydrate TiSO₄×H₂O

b) TiO₂ in H₂O, 1 wt. %

c) Tetraethyl orthotitanate

d) Tetraisopropyl [sic—Tr.] orthotitanate (titanium-IV-isopropylate)

e) Titanium(IV) ethylate

f) Titanium(IV) butyl orthotitanate

g) Titanium acetyl acetonate

Freshly precipitated TiO₂.H₂O in the joining solutions readily dissolves again by adding NH₃ and Na₂CO₃ (intermediate formation of (NH₄)₂CO₃) (see comments under C).

E. Zinc Compounds

Readily soluble zinc acetates, nitrates and sulfates form zinc hydroxide in basic solutions. Zn(OH)₂ is amphoteric and tends towards complex formation (e.g., with tartaric acid), in the case of excess liquor zinc hydroxide formed in the interim dissolves, whereby a zincate is formed Na[Zn(OH)₃]; zinc compounds lead to an improvement in the chemical resistance of the joining solution and to slowing down of the curing. According to the present invention, the following may be used, above all:

a) Zinc acetate

b) Zinc nitrate Zn(NO₃)₂

c) Zinc sulfate-7-hydrate

F. Zirconium Compounds

Zirconium compounds are used to improve the chemical resistance of the joining solution and to slow down the curing. Suitable above all are:

a) Zirconium sulfate Zr(SO₄)₂

b) Zirconium(IV) isopropoxide-isopropanol complex

c) Zirconium propylate 77% in n-propanol

d) Zirconium-2,4 pentanedionate

e) Zirconium-n-propylate

f) Zirconium(IV)-acetonate 98%

g) Zirconium(IV) oxide in water 1%

h) Zirconium ethoxide

i) Zirconium nitrate Zr(NO₃)₄

k) Zirconium(IV) oxide chloride-8-hydrate.

G. Yttrium Compounds

Yttrium compounds are used to improve the chemical resistance of the joining solution and to slow down the curing. According to the present invention, the following are especially suitable:

a) Yttrium chloride hexahydrate

b) Yttrium acetate hydrate 1%

c) Yttrium nitrate Y(NO₃)₃.6H₂O.

A reduction of the pH value is achieved by dilution and additions to the basic joining solutions (see Table 4), which in turn leads to the slowing down of the curing. The attack of less basic joining solutions on the surfaces of glass or glass ceramic joined components slows down diffusion of the components into the surfaces of the joined parts, neutralization of the joining solution (preferably by the CO₂ in the surrounding air), removal of water as well as the solution-sol-gel-solid colloidal glass layer transition and thus the formation of new Si—O—Si bonds between the components.

In Zr— or Y-containing solutions, the precipitation as hydroxide in the joining solutions due to the formation of complexes of varying stability can be prevented by adding tartaric acid or citric acid.

TABLE 4
pH values of various joining solutions

| Joining solution | pH value |
|---|---|
| NaOH 2% | 13.2 |
| K soluble glass | 12.8 |
| Na soluble glass | 12.6 |
| ISC 5 Na soluble glass + saturated H₃BO₃ | 12.2 |
| solution (9:1) | |
| Al silicate + Na soluble glass | 12 |
| Al silicate + Li soluble glass (1:9) | 11.6 |
| Li soluble glass | 11.8 |
| Levasil 300/30% | 10.1 |
| Boric acid H₃BO₃, saturated (5%) | 3.7 |

After reacting chemically with one another and with the components of the surfaces of the parts to be joined, the components of the joining solutions form and stabilize the network of the joining compound and meet different requirements.

TABLE 5
Action of the components of the joining solutions on the solid joint formed

| Component in the | | |
|---|---|---|
| network between | | |
| joined surfaces | Portion in wt. % | Action |
| H₂O | 10-99 | Solvent, hydrogen bridge bonds, removed in solid joints |
| SiO₂ | 10-99 | Linking tendency of SiO₄-tetrahedron, Si—O—Si bonds, |
| | | increase in chemical resistance |
| Na₂O | 0-50 | Na⁺/NBO (non-bridge oxygen, SiO—) bond |
| K₂O | 0-50 | K⁺/NBO (non-bridge oxygen, SiO—) bond |
| Li₂O | 0-50 | Li⁺/NBO (non-bridge oxygen, SiO—) bond |
| B₂O₃ | 0-50 | Slowing down of curing, lowering of the coefficients of |
| | | thermal expansion, combined with SiO₂ improvement in |
| | | the chemical, mechanical and thermal stability of the joint, |
| | | additional improvement in the chemical resistance due to |
| | | addition of Al₂O₃, may act as network former and/or as |
| | | network modifier depending on coordination number |
| Al₂O₃ | 0-50 | Reduction of pH value, slowing down of curing, increase |
| | | in the temperature resistance and the chemical resistance |
| | | of the bond, Zerodur-like intermediate layer (Li-alumo- |
| | | silicate-glass ceramic), improvement in the mechanical |
| | | stability of the joint, lowering of the coefficients of |
| | | thermal expansion, increase in refraction of light, may act |
| | | as network former and/or as network modifier depending |
| | | on coordination number |
| TiO₂ | 0-50 | Slowing down of curing, adaptation of the coefficients of |
| | | thermal expansion, increase in glass hardness, and acid |
| | | resistance, reduction in alkali [sic] resistance, as Ti⁴⁺ may |
| | | act as network modifier, [TiO₆]⁴⁻ as Ti⁶⁺ as network former |
| | | [TiO₄]²⁻ , increase in refraction of light of the joint |
| Y₂O₃ | 0-50 | Improvement in the temperature and chemical resistance, |
| | | slowing down of curing, thermodynamically stable |
| ZrO₂ | 0-50 | Slowing down of curing, improvement in the chemical |
| | | resistance of the joint |
| ZnO | 0-50 | Slowing down of curing, improvement in the chemical |
| | | resistance of the joint over water, may act as network |
| | | former and/or network modifier depending on coordination |
| | | number |
| ZnO | 0-50 | Improvement in the chemical resistance of the joint over |
| | | water, may act as network former and/or network modifier |
| | | depending on the coordination number |

The course of the joining process shall be explained in detail below.

The process begins preferably with cleaning of the parts (bath cleaning or RCA cleaning) according to the above description by means of a pretreatment of the joined surfaces (e.g., with lyes, acids, silanization). This is followed by the application of the joining solution (e.g., with adjustable pipette/syringe/dispensing needle by means of applying drops and possibly centrifuging [spin coating]), wherein the typical amount of joining solution applied is greater than/equal to 0.8 μL/cm² of joined surface. After that, the joining is brought about by placing one joining body onto the other joining body from above or pushing it on from the side. This takes place, e.g., while a drop is deposited on the bottom sample and the upper sample is dipped at the end of the drop and is then pushed over the drop. The joined surface between the samples is filled by capillary action. Within the period that is available for adjusting, the joining bodies are then possibly moved and aligned in relation to each other. The joining partners are then fixed at room temperature for approx. 15 min. up to approx. 12 hr. (preferably under slight pressure, for example, approx. 10⁴ N/m²). The subsequent resting times are approx. 0.5 hr. to 4 hr., in air or in the desiccator. The short times are especially suitable for small joined surfaces (a few cm²), which long for rather larger surfaces [sic, word(s) missing from the original?—Tr.] (50-100 cm²). A careful and possibly vibration-free insertion of the bonded parts into a vacuum chamber or an oven is necessary for this. The solvent water is slowly removed by a drying process. A chemical bond of the joined surfaces is built up here. This build-up is preferably supported by vacuum (low vacuum of approx. 1 mbar is sufficient) at room temperature for approx. 3-10 days with or without applying weights. Finally, heat treatment follows in the oven (preferably under vacuum, standard atmosphere), preferably at approx. 80° C., 200° C. max. It lasts a few minutes to two weeks.

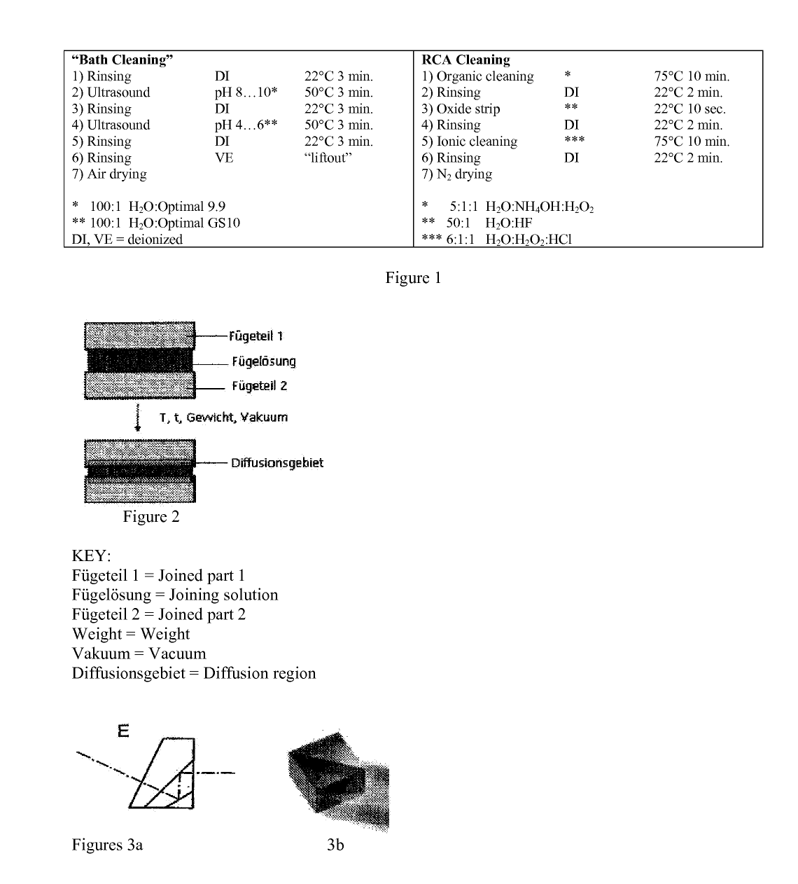

Compared to standard atmosphere with the usual relative humidity of approx. 50%, drying under vacuum has the advantage that the outer area around the joined surface is entirely free from water vapor, and a back reaction, in which moisture/water from outside diffuses into the joined surface, is ruled out. The increased moisture gradient between joined surface and exterior advances the drying out of the joined surface very efficiently and thus provides good dehydration and high solidification in a short time. Even gases dissolved, adsorbed or formed by reaction during the joining process, which are mobile and reach the edge of the joined surface via diffusion processes, are suctioned out there during vacuum drying. This contributes to an increased quality of the bond and guarantees a problem-free later use of the bonded components under vacuum (e.g., in space). During the joining process, components of the joining solution diffuse into the surfaces to be joined (see representation in FIG. 2). A network, which binds the components to be joined on the atomic level, is formed via covalent Si—O bonds and other bonding mechanisms (single and multiple bonds, hydrogen bridge bonding, bonding of alkali ions with non-bridge oxygen, Si—O—Si network bonding).

Diffusion and reaction processes in the joining zone may be actively supported in the drying phase by infrared radiation. Dehydration of the joining zone is, of course, more difficult, the greater is the extension or distance to the edge. It has been shown that active infrared radiation leads to improved bond results and reduces the appearance of visually visible defects especially in relatively extensive joining zones during vacuum drying at room temperature.

Above all, approximately “black-body radiators” with a temperature of 250-500° C. are suitable as radiation sources. The radiation is preferably directed at the center of the joined surface, and the power density is preferably set such that the samples are essentially not heated during the vacuum drying, i.e., the temperature preferably does not rise above 30° C., at any rate not above 50° C.

The layer thicknesses of the joints may usually be between 10 nm and 2 μm with the main focus at approx. 150 nm to 500 nm depending on the joining solution, the manner and amount of application and the application of weights.

Climatic tests (according to DIN ISO 9022-2) show that joints of this type are stable for a long time even under varying environmental conditions. In joints of so-called “zero” expansion [sic] materials (e.g., ULE, Zerodur), even low-temperature tests were passed, in which the bonded parts had been dipped in liquid nitrogen (i.e., cooled up to approx. 80° K.) and then warmed up in air again to room temperature. This proves the excellent long-term stability of the joints according to the present invention. The first successful joints have been stable since January 2006 (as of September 2007) and thus for over 20 months to date.

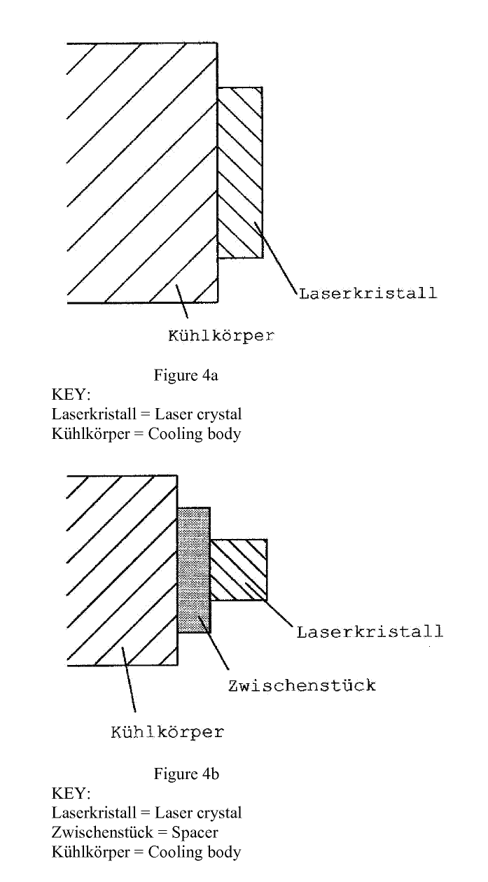

The process according to the present invention is especially suitable for the following applications:
Fiber Bonding. In fiber bonding, usually glass fibers made of SiO₂ are present, which shall be embedded in V-shaped grooves with extremely low positional tolerances “on impact.” These V-shaped grooves are frequently made of silicon by anisotropic etching. The natural (or artificial) oxidation of silicon on the surface creates an outstandingly suitable bonding surface for silicate bonds and the relative “low-viscosity” bond solution leads to a very good wetting of the fiber. The fiber is preferably pressed “dry” into the V-shaped groove and then fixed there until the solution is introduced, dried out and the bonding process is completely finished.
Fiber to Ferrule Bonding. The process is analogous in “fiber to ferrule” bonding, i.e., fibers into fiber connector. The fiber connector may be embodied in the form of two half shells or as a hollow cylinder, into which the fiber is inserted before the bonding solution is applied and the bond is dried. Because of the low viscosity of the joining solution, pairings that fit very exactly are possible, which make possible a small layer thickness of the bond and a good dissipation of heat from the fiber to the ferrule and—compared to polymers—allow elevated temperatures. This is advantageous, e.g., for high-performance fiber lasers, where frequently great power losses form at the ends of the laser fibers. Also, the bond layer to the ferrule may be made “turbid” by means of suitable solutions and scatter or absorb parasitic radiation and dissipate the heat loss to the (possibly water-cooled) ferrule.
Stable Precision Bond.
Temperature-resistant ultrathin bonding with good heat transfer (for cooling).
Sensory engineering applications (see, e.g., Smart Mater. Struct., 8: 175-181 (1999)).
Prism bonding (bonding of two prisms with one another, “prism-to-prism”, bonding of a prism with a substrate, “prism-to-plane”, shown in FIGS. 3a and 3b).
Optical platforms (stable precision compounds).
Transparent compounds of non-linear optical crystals (LiNiO₃, BaTiO₃, or the like) with prisms or glass lenses for optical modulators.
Disk lasers (stable precision bonds). FIGS. 4a and 4b show a laser crystal without or with a spacer bonded to a cooling body, respectively. (The spacer is thus used “mechanically” for thermal adaptation in case of different coefficients of expansion of cooling body and laser crystal or even “functionally” for the so-called “Q-switching” of the laser, e.g., in the form of a SESAM=Semiconductor Saturable Absorber Mirror). The silicate bond layer may, in the second case, comprise both the bonding of the laser crystal with the spacer and bonding of the spacer with the cooling body. Of course, the material properties of the cooling body and spacer are to be taken into consideration here. Optionally, thin SiO₂ layers (approx. 10 nm) may be applied by means of sputtering of similar thin-layer techniques before silicate bonding.
Stable bonds of laser crystals (Yb:YAG, Nd:YVO₄ or the like) with carrier materials, such as sapphire or Si (or surface-oxidized Si) for stable holding and dissipation of heat in disk lasers.
Creep-resistance bonds of optical elements with ceramics, even bonding of piezo-ceramics with optical components or nonlinear optical crystals, for changing optical properties via electrical control.

The present invention is explained below on the basis of exemplary embodiments. It should be clear here that the features of various exemplary embodiments may be combined with one another. The glass or glass ceramic surfaces to be bonded are chemically activated with additives and then solidly joined by means of an inorganic aqueous solution or suspension at low temperatures. All tests take place in a clean room. The components may consist of, among others, Zerodur from Schott, ULE from Corning, silica glass (e.g., Lithosil) from Schott, BK7 or Borofloat glass from Schott. Round disks made of these materials having the following properties were typically used: Diameter 25 mm, height 10 to 11 mm, polished on both sides and numbered continuously by means of engraving.

For cleaning and activating the surfaces of components to be joined, at least one of the following processes is used in conjunction with the RCA standard process (see Table 3) for cleaning silicon wafers (see FIG. 1):
1. Commercially available glass cleaner
2. Analogous “RCA standard cleaning”

Some of the joining surfaces [sic—Tr.] are additionally activated (30 min. treatment in 10% HNO₃, rinsing off with deionized water, drying times of 1.5 to 2 hr.).

The period between cleaning/activation and joining should be no longer than 6 days, preferably≦1 day.

New chemical bonds form during the contacting. Upon evaporation of the water from the joining solution due to low-temperature treatment, a solid, ultrathin intermediate layer forms. The joining process is divided into three main steps (see above):
Cleaning, activation of the surfaces to be joined (basic, acidic, hydrophilic, and possibly silanization)
Application of the joining solution and contacting of the parts, adjustment
Resting periods, loading with weights
Removal of water/drying and chemical bonding of the parts (curing).

The joining solution may be applied manually by means of a syringe, pipette, dispensing needle, but also, e.g., by means of spin coating or a similar method. After the application, drying may possibly be carried out. This makes it possible to adjust the two parts to be bonded “in the dry state” and then to activate the solution at first in a moist environment (e.g., in water vapor) and to cause [it] to react with the substrates, and subsequently again to carry out a water removal/drying process as described below.

The joined parts are joined together by placing on or pushing on from the side. Subsequently [sic—Tr.], the joined parts are adjusted in relation to one another. The joint cures into a solid bond.

Water removal/drying may at first take place at room temperature in air and/or even under vacuum with or without application of weights. A period of approx. 3 hr. up to approx. 6 days is preferably suitable. This is followed by a heat treatment in the oven at temperatures of approx. 60° C. to 110° C. in order to stabilize the bond. This may likewise take place in air or under vacuum.

After the individual process steps, the properties of the activated glass and glass ceramic surfaces, intermediate layer and joint are characterized as follows:

1. Optical Rating of the Joined Samples and Light Microscopy

The samples were visually rated immediately after the drying process; a score system of 1 to 5 was used for this, with which the size and number of defects, bubbles and interferences were defined. Moreover, the position and intensity of turbidities were described in addition to this.

Score 1: no visible defects

Score 2: very small defects, such as bubbles

Score 3: several small defects, visually readily visible

Score 4: markedly visible defects

Score 5: 50% of the surface with defects

This is then followed by the exact inspection using a microscope of the samples with subsequent documentation with pictures. Course of process: lens used: 2.5×, height adjustment on a defined test disk with readily visible defects, on the test disk slow searching of the surfaces for defects, bubbles and turbidities, documentation of the defects with drawing and picture (analysis).

2. Layer Thickness

For further characterization of the layer forming during bonding, an analysis of the layer thickness was performed using a “TESA-μhite PIM100” length meter. The weight, which loads the joined surface during the bonding, besides the upper disk, was varied here.

Rupture Rest (Three-Point Bending Tests)

In order to be able to determine the mechanical loadability of the joined disks, rupture test rods that have the joined area in the middle of the front surfaces were sawed from the glass disks, which have a good quality optically. Rupture test rods, which have a square base with an edge length of b=h=6 cm, were measured. The length varied depending on the material used. The sawed rupture test rods were tested with the three-point bending test on an “Instron 4464” compression-tension machine. In this case, the maximum bending stress was applied to the joined surface and loaded until rupture. In order to guarantee tilting of the plane-parallel top and bottom sides, the samples in the meter were provided with a degree of freedom, so that the samples could be aligned parallel to the punch.

Good results of the mechanical loadability of joined surfaces were achieved (30 MPa to 60 MPa). In comparison, solid glass has typical strengths of 60 MPa. Only Borofloat proves to be very poorly joinable, since the rupture stresses were much worse than in the other materials. A re-tempering after sawing does not lead to improvement in the joined surface.

### Exemplary Embodiment 1 (Comparison Example)

Low-Temperature Joining of Two ULE Round Disks

Cleaning: RCA cleaning

Joining solution: ISC 1 (Na soluble glass solution)

Joining process: Central dropping of the joining solution with a pipette, adjusting time 1 min., application of weight (400 g) for 60 min., then heat treatment for 48 hr. in oven at 80° C. and normal atmosphere

Result: Adjusting time 1 min., stable joint, optically clear and transparent joined surface

Optical rating: Score 1

Three-point bending strength: 55 MPa

Layer thickness: 0.9 μm

### Exemplary Embodiment 2

Low-Temperature Joining of Two BK7 Round Disks

Cleaning: RCA cleaning

Joining solution: ISC 5 (sodium soluble glass+boric acid, saturated solution)

Joining process: Central dropping of the joining solution with a pipette, adjusting time 3 min., then loaded with 500 g for 25 min at room temperature and normal atmosphere, drying in air for 20 min at room temperature, oven for 8 hr. at 80° C., normal atmosphere. Result: Extension of the adjusting time by adding B₂O₃ and reduction of the pH value to 11.9 in 3 min. Boric acid H₃BO₃ is readily soluble in water upon heating, poorly soluble in cold, it is a weak acid and is used for neutralizing the basic soluble glass solution, slows down its chemical reactions with the joined surfaces and the CO₂ in the air as well as the formation of water-insoluble boron silicate bonds Si—O—B from water-soluble alkali borates, such that the joining and adjusting times are extended, solid joint, joined surface optically clear and transparent

Optical rating: Score 1

### Exemplary Embodiment 3

Low-Temperature Joining of Two ULE Round Disks

Cleaning: RCA cleaning

Joining solution: Silica sol Levasil 300/30%+1 vol. % tetraethyl orthotitanate (3 wt. %)+2 vol. % NH₃—Na₂CO₃ (100 mL NH_{3 aq} 24% in water+10 g Na₂CO₃).

Joining process: Central dropping of the joining solution with a pipette, adjusting time 4 min., application of weight (100 g) for 5 min , drying in air for 20 min. at room temperature and normal atmosphere, then heat treatment for 8 hr. in oven at 80° C. and normal atmosphere. Result: Adjusting time up to 4 min. by basic joining solution silica sol (pH 10.1) and addition of a titanium-containing bond as well as stabilization of the joining solution with (NH₄)₂CO₃. The pH value of the resulting joining solution is 9.8. Since ULE consists of SiO₂ and TiO₂, the titanium-containing joint additionally leads to a higher strength of the joint (40 MPa instead of 30 MPa compared to a silica sol solution without Ti bond). A stable joint with optically clear and transparent joined surface is obtained.

Optical rating: Score 1

### Exemplary Embodiment 4

Low-Temperature Joining of Two Zerodur Round Disks

Cleaning: RCA cleaning

Joining solution: Lithium soluble glass solution+aluminum silicate solution (volume ratio 9:1)+5 vol. % ammonia solution (NH₃.H₂O, 24% in water, firm of Fluka), pH value of the joining solution 11.6.

Joining process: Central dropping of the joining solution with a glass rod, adjusting time 4 min., application of weight (400 g) for 60 min , drying in air for 20 min. at room temperature and normal atmosphere, then heat treatment for 8 hr. in oven at 80° C. and normal atmosphere. Result: Adjusting time up to 4 min. by adding aluminum silicate solution and ammonia solution (NH₃.H₂O) to the lithium soluble glass, ammonia solution (NH₃.H₂O) dissolves the aluminum hydroxide formed in the interim in the basic lithium silicate solution under complex formation, this solution acts as a buffer solution. A stable joint, but a uniformly milky rather than optically clear and transparent joined surface is obtained. The process is therefore suitable for joints, in which no optical passage through the joined surfaces is needed.

Optical rating: Score 4

### Exemplary Embodiment 5

Low-Temperature Joining of Two Zerodur Round Disks

Cleaning: RCA cleaning

Joining solution: 90 wt. % lithium soluble glass solution (ISC 1)+10 wt. % zinc acetate (pH of the joining solution 11.4)

Joining process: Central dropping of the joining solution with a pipette, adjusting time 5 min., application of weight (100 g) for 5 min , drying in air for 20 min. at room temperature and normal atmosphere, then heat treatment for 8 hr. in oven at 80° C. and normal atmosphere. Result: Adjusting time up to 5 min. by adding zinc acetate to sodium soluble glass solution, zinc acetate reacts with the strongly basic sodium silicate solution into zinc hydroxide. Zn(OH)₂ is amphoteric and tends to form complexes in case of excess liquor, dissolves and leads to a moderate reduction of the pH value of the joining solution. A stable joint, but a partly milky rather than optically clear and transparent joined surface is obtained. The process is suitable for joints, in which no optical passage through the joined surfaces is needed.

Optical rating: Score 4

### Exemplary Embodiment 6

Low-Temperature Joining of a ULE Round Disk and a BK7 Round Disk

Cleaning: Bath cleaning

Joining solution: 95 vol. % ISC 3 (Na soluble glass:water=1:2), 5 vol. % trimethyl borate (purity≧99.0%, firm of Fluka)

Joining process: Joining by pushing on the joined parts, adjusting time 4 min., application of weight (500 g) for 15 min. in air at room temperature, then curing for 72 hr. under vacuum (5 mbar) at room temperature, subsequent heat treatment in vacuum oven (5 mbar, 70° C., heating rate 20 K/hr., 24 hr.). Result: The adjusting time was increased to 4 min. by dilution, a solid joint with an optically clear and transparent joined surface, only sporadic bubbles, is obtained.

Optical rating: Score 2

Three-point bending strength: 53 MPa

Layer thickness: 0.7 μm

### Exemplary Embodiment 7

Low-Temperature Joining of a ULE Round Disk and a Lithosil Round Disk

Cleaning: RCA cleaning

Joining solution: 90 vol. % ISC 3 (Na soluble glass:water=1:2), 8 vol. % TiO₂ in water (1 wt. %), stabilization by 2 vol. % (NH₄)₂CO₃ (100 mL NH_{3 aq} 24% in water+10 g Na₂CO₃), pH value of the joining solution 11.5

Joining process: Joining by pushing on the joined parts, adjusting time 4 min., application of weight (400 g) for 15 min. in air at room temperature, then curing for 72 hr. in air at room temperature, subsequent heat treatment in oven (80° C., 24 hr.).

Result: Adjusting time increased to 4 min., solid joint, optically clear and transparent joined surface.

Optical rating: Score 1

Three-point bending strength: 50 MPa

Layer thickness: 0.7 μm

1. Process for joining two or more components made of glass, ceramic and/or glass ceramic using a soluble glass joining solution having sodium, potassium and/or lithium ions and/or a silica sol, in which the joining solution and/or silica sol is applied to joined surfaces between the components to be joined and solidified at mild temperatures, characterized in that the joining solution and/or silica sol contains at least one additive, selected from among boric acid, boron compounds, from which boric acid can be formed by hydrolysis, aluminum acetates, aluminum silicates, titanium compounds, which form titanium hydroxy cations in aqueous solution, water-soluble zinc compounds, water-soluble zirconium compounds and water-soluble yttrium compounds, wherein the additive is added in an amount that reduces the pH value of the underlying soluble glass joining solution and/or of the underlying silica sol.

2. Process for joining two or more components made of glass, ceramic and/or glass ceramic using a soluble glass joining solution having sodium, potassium and/or lithium ions and/or a silica sol, in which the joining solution and/or silica sol is applied to joined surfaces between the components to be joined and solidified at mild temperatures, wherein after the joining solution and/or silica sol is applied and the components to be joined are brought together and fixed, the joining components are dried by removing water at room temperature, characterized in that, after drying, the joined components are tempered under vacuum at a temperature in the range of up to 200° C. above room temperature.

3. Process in accordance with claim 1, wherein the components are cleaned with an RCA cleaning process or a bath cleaning before joining.

4. Process in accordance with claim 1, wherein the joined surfaces of the components are pretreated before joining with a basic medium, preferably NaOH or KOH, or an acidic medium, preferably HF.

5. Process in accordance with claim 1, wherein the joined surfaces of the components are silanized before joining, preferably using fluorosilanes, especially perfluorododecyl-triethoxysilane, organically cross-linkable alkoxysilanes, especially 3-methacryloxy-propyltrimethoxysilane or amino-group-modified alkoxysilanes, especially aminopropyltrimethoxysilane, in such a way that a hydrophobic contact angle in the range of 50° to 75° is formed.

6. Process in accordance with claim 1, wherein the components to be joined are provided with a thin SiO₂ layer before the low-temperature joining via a PVD process, especially by sputtering.

7. Process in accordance with claim 1, wherein the joining solution contains, as a basis, a soluble glass solution of Na₂Si₃O₇, K₂Si₃O₇, Li₂Si₃O₇ or a silica sol with 100 m²/g SiO₂/45% SiO₂/100 parts of silica sol, 200 m²/g SiO₂/40% SiO₂/100 parts of silica sol or 300 m²/g SiO₂/30% SiO₂/100 parts of silica sol in water in a concentration of 10 to 99 vol. %, and especially contains neutral to slightly basic sodium soluble glass with an SiO₂:Na₂O molar ratio of 3.5 (solids content approx. 39%), potassium soluble glass with an SiO₂:K₂O molar ratio of 2.9 (solids content approx. 40%) or lithium soluble glass with an SiO₂:Li₂O molar ratio of 2.5 (solids content approx. 27.2%).

8. Process in accordance with claim 1, wherein the joining solution contains up to 50 vol. % of an ammonia solution in water, preferably 24% NH₃ in water.

9. Process in accordance with claim 1, wherein the joining solution contains up to 50 wt. % of one or more of the following compounds:
B₂O₃ in the form of a saturated suspension in water in a portion of up to 5 vol. %),
boric acid (H₃BO₃),
trimethyl-borate (B(OCH₃)₃),
aluminum silicate,
Al(OOCCH₃)₃,
HOAl(OOCCH₃)₂,
tetraisopropyl-orthotitanate (titanium-IV-isopropylate), titanium(IV)-ethylate, titanium acetylacetonate,
titanium hydrate TiSO₄×H₂O),
TiO₂ in H₂O in a portion of up to 1 wt. %,
zinc acetate,
zinc sulfate-7-hydrate,
zinc nitrate,
zirconium sulfate (Zr(SO₄)₂),
zirconium(IV)isopropoxide-isopropanol complex,
zirconium propylate 77% in n-propanol,
zirconium-2,4 pentanedionate,
zirconium nitrate Zr(NO₃)₄),
zirconium-n-propylate,
zirconium(IV) oxide in water in a portion of up to 1 wt. %,
zirconium ethoxide
zirconium(IV) oxide chloride-8-hydrate,
yttrium nitrate (Y(NO₃)₃×6H₂O),
yttrium chloride hexahydrate, or
yttrium acetate hydrate in a portion of up to 1 vol. %.

10. Process in accordance with claim 1, wherein the pH value of the joining solution is between 9 and 13, preferably between 10 and 12.6.

11. Process in accordance with claim 1, wherein the joining temperature is below 100° C., preferably between 50° C. and 80° C.

12. Process in accordance with claim 1, wherein a period of 3 to 6 minutes remains after applying the joining solution to adjust the components to one another.

13. Process in accordance with claim 1, wherein after the joining solution is applied and after the components are adjusted to one another, the joined components are dried at room temperature in air in a water-removing environment, for example, a desiccator, or in a dry N₂ gas stream.

14. Process in accordance with claim 13, wherein the duration of the drying is 2 minutes to 8 days, preferably 5 to 60 minutes and especially preferably 5 to 15 minutes.

15. Process in accordance with claim 13, wherein the drying is carried out at room temperature under vacuum with a pressure less than 10 mbar and preferably at 0.1 mbar to 2 mbar.

16. Process in accordance with claim 15, wherein the drying under vacuum is supported by infrared radiation and the temperature in the joining zone does not rise above 50° C. and preferably does not rise above 30° C.

17. Process in accordance with claim 13, wherein the drying is carried out under vacuum, preferably with a pressure less than 10 mbar, more preferably at approximately 0.5 mbar to 2 mbar and especially preferably at approximately 1 mbar.

18. Process in accordance with claim 13, characterized in that, after drying, the joined components are tempered under vacuum.

19. Process in accordance with claim 18, characterized in that the tempering is carried out at a pressure of below 10 mbar and preferably at 0.1 mbar to 2 mbar or at a temperature in the range between 50° C. and 150° C., and preferably between 70° C. and 120° C.

20. Process in accordance with claim 18, wherein the tempering is carried out for a period of 2 minutes to two weeks, preferably for ½ day to 1 week, especially preferably from 8 hours to 72 hours and very especially preferably from 8 hours to 24 hours.

21. Process in accordance with claim 13, wherein the drying or the tempering are carried out while applying a weight, by means of which a pressure of 1,000 to 100,000 N/m², preferably of approximately 10,000 N/m² acts on the binding surface of the parts.

22. Process in accordance with claim 1, wherein the components to be joined are made of glass, especially of soda lime silicate glass, boron crown glass, borofloat glass, silica glass or doped silica glass, or of glass ceramic, especially Zerodur.

23. Process in accordance with claim 1, wherein the gap between the components to be joined has a thickness of less than 2 m, preferably less than 160 nm and wherein the surfaces of the components to be joined have a flatness deviation (PV=peak-to-valley) of less than 160 nm and a roughness (RMS=root mean square) of less than 30 nm, preferably less than 3 nm and very especially preferably less than 1 nm at the joined surfaces.

24. Process in accordance with claim 1, wherein the components to be joined are optical components, micromechanical components or materials that preferably do not expand in case of changes in temperature.

25. Process according to claim 1, wherein after the joining solution and/or silica sol is applied and the components to be joined are brought together and fixed, the joining components are dried by removing water at room temperature, characterized in that, after drying, the joined components are tempered under vacuum at a temperature in the range of up to 200° C. above room temperature.

26. Process in accordance with claim 2, wherein the joining solution contains up to 50 wt. % of one or more of the following compounds:
B₂O₃ in the form of a saturated suspension in water in a portion of up to 5 vol. %),
boric acid (H₃BO₃),
trimethyl-borate (B(OCH₃)₃),
aluminum silicate,
Al(OOCCH₃)₃,
HOAl(OOCCH₃)₂,
tetraisopropyl-orthotitanate (titanium-IV-isopropylate), titanium(IV)-ethylate,
titanium acetylacetonate,
titanium hydrate (TiSO₄×H₂O),
TiO₂ in H₂O in a portion of up to 1 wt. %,
zinc acetate,
zinc sulfate-7-hydrate,
zinc nitrate,
zirconium sulfate (Zr(SO₄)₂),
zirconium(IV)isopropoxide-isopropanol complex,
zirconium propylate 77% in n-propanol,
zirconium-2,4 pentanedionate,
zirconium nitrate (Zr(NO₃)₄),
zirconium-n-propylate,
zirconium(IV) oxide in water in a portion of up to 1 wt. %,
zirconium ethoxide
zirconium(IV) oxide chloride-8-hydrate,
yttrium nitrate (Y(NO₃)₃×6H₂O),
yttrium chloride hexahydrate, or
yttrium acetate hydrate in a portion of up to 1 vol. %.
